(19) United States
(12) Patent Application Publication
(10) Pub. No.: US 2015/0026306 A1
(43) Pub. Date: Jan. 22, 2015

(54) METHOD AND APPARATUS FOR PROVIDING VIRTUAL DESKTOP SERVICE

(71) Applicant: ELECTRONICS AND TELECOMMUNICATIONS RESEARCH INSTITUTE, Daejeon (KR)

(72) Inventors: Jong Bae MOON, Daejeon (KR); Dae Won KIM, Daejeon (KR); Sun Wook KIM, Kyunggi-do (KR); SooCheol OH, Daejeon (KR); Hak jae KIM, Daejeon (KR); Jung-hyun CHO, Daejeon (KR); Myeong-Hoon OH, Daejeon (KR); Seong Woon KIM, Chungcheongnam-do (KR); Hag Young KIM, Daejeon (KR)

(73) Assignee: ELECTRONICS AND TELECOMMUNICATIONS RESEARCH INSTITUTE, Daejeon (KR)

(21) Appl. No.: 14/108,925

(22) Filed: Dec. 17, 2013

(30) Foreign Application Priority Data
Jul. 16, 2013 (KR) 10-2013-0083791

(51) Int. Cl. H04L 29/08; H04L 12/24

(52) U.S. Cl. CPC H04L 67/10; H04L 41/50
USPC 709/219; 709/226

(57) ABSTRACT

A method and an apparatus for providing a virtual desktop service to provide an optimal virtual desktop service in accordance with distances between virtualization servers and a user are provided. A virtual desktop service suitable for a request of the user is provided to the user so that loads of servers may be dispersed and power usage of the servers may be minimized. That is, in an environment where the virtualization servers that provide the virtual desktop service are locally dispersed, the virtual machines may be allocated to a virtualization server with a shortest network delay based on network distances from the virtualization servers to the user. In addition, after a server power usage amount is predicted in accordance with a virtual machine usage type of the user, a virtualization server may be selected in accordance with the prediction result.

### CROSS-REFERENCE TO RELATED APPLICATION

This application claims priority to and the benefit of Korean Patent Application No. 10-2013-0083791 filed in the Korean Intellectual Property Office on Jul. 16, 2013, the entire contents of which are incorporated herein by reference.

### BACKGROUND OF THE INVENTION

(a) Field of the Invention

The present invention relates to a method and an apparatus for providing a virtual desktop service in cloud computing for virtualizing a desktop.

(b) Description of the Related Art

In general, in a server virtualization computing environment, virtual machines are allocated to users based on performances and loads of resources (central processor units (CPU), memories, disk capacities, and a network) of virtualization servers. At this time, in a virtual desktop service, since screens of virtual machines are remotely transmitted to users, quality of service may vary in accordance with network delay caused by distances between dispersed users and dispersed virtualization servers.

In a dispersed network environment, a plurality of servers that provide virtual machines may be locally concentrated and may be dispersed in a wide area. When the plurality of servers are dispersed in a wide area, there are limitations of a method of allocating the virtual machines based on loads of hardware resources.

### SUMMARY OF THE INVENTION

Therefore, according to an exemplary embodiment of the present invention, a method and an apparatus for allocating a virtual machine to provide a virtual desktop service in accordance with distances between virtualization servers and a user and a server usage pattern of the user are provided.

According to an exemplary embodiment of the present invention, a method of providing a virtual desktop service to a user is provided. The virtual desktop service providing method includes determining whether a plurality of virtualization servers included in a network are dispersed, when it is determined that the plurality of virtualization servers are dispersed, measuring network distances between the user and the plurality of virtualization servers, selecting at least one virtualization server among the plurality of virtualization servers based on the measured network distances, and transmitting driving commands on virtual machines to the selected virtualization server.

Selecting the virtualization server may include selecting a virtualization server with the shortest network distance among the plurality of virtualization servers.

In the virtual desktop service providing method, selecting the virtualization server may include, when m virtualization servers with the shortest network distance exist among the plurality of virtualization servers, comparing resource usage rates of the m virtualization servers with each other and selecting a virtualization server with the smallest resource usage rate.

The virtual desktop service providing method may further include, when resource usage rates of the m virtualization servers are similar to each other, comparing the numbers of virtual machines that are being driven in the m virtualization servers with each other and selecting a virtualization server with the smallest number of virtual machines that are being driven among the m virtualization servers.

The virtual desktop service providing method may further include sequentially selecting the m virtualization servers when the numbers of virtual machines that are being driven in the m virtualization servers are equal to each other.

The virtual desktop service providing method may further include, when the plurality of virtualization servers are concentrated, comparing performances of the plurality of virtualization servers with each other and selecting a virtualization server with highest performance among the plurality of virtualization servers.

According to another exemplary embodiment of the present invention, another method of providing a virtual desktop service to a user is provided. The virtual desktop service providing method includes, when a virtual desktop service request is received from the user, grouping a work type of the user, selecting a predetermined virtualization server in accordance with the grouping result, and transmitting driving commands on virtual machines to the selected virtualization server.

The virtual desktop service providing method may further include, when a virtual desktop service request is received from the user, predicting a server power usage amount in accordance with a usage pattern of the user, selecting a virtualization server based on the server power usage amount, and transmitting driving commands on virtual machines to the selected virtualization server.

In the virtual desktop service providing method, predicting the server power usage amount may include calculating the usage pattern through an average resource usage amount of the user in a predetermined period.

In the virtual desktop service providing method, calculating the usage pattern may include calculating the usage pattern by a data mining technique.

According to another exemplary embodiment of the present invention, an apparatus for providing a virtual desktop service to a user is provided. The virtual desktop service providing apparatus includes a distance measurer for, when a plurality of virtualization servers included in a network are dispersed, measuring network distances between the user and the plurality of virtualization servers, a scheduler for selecting at least one virtualization server among the plurality of virtualization servers as a virtualization server for driving virtual machines in accordance with a policy and transmitting driving commands on the virtual machines to the selected virtualization server, and a service provider for, when the virtual machines are driven, providing the virtual desktop service to the user.

In the virtual desktop service providing apparatus, the scheduler may select a virtualization server with the shortest measured network distance.

In the virtual desktop service providing apparatus, when m virtualization servers with the shortest measured network distance exist, the scheduler may compare resource usage rates of the m virtualization servers with each other to select a virtualization server with a smallest resource usage rate.

In the virtual desktop service providing apparatus, when the resource usage rates of the m virtualization servers are similar to each other, the scheduler may select a virtualization server with the smallest number of virtual machines that are being driven.

In the virtual desktop service providing apparatus, when the numbers of virtual machines that are being driven in the m virtualization servers are equal to each other, the scheduler may sequentially select the m virtualization servers.

In the virtual desktop service providing apparatus, the scheduler may predict a server power usage amount in accordance with a usage pattern of the user, and may select a virtualization server based on the predicted server power usage amount.

In the virtual desktop service providing apparatus, the scheduler may calculate the usage pattern through an average resource usage amount of the user in a predetermined period.

### BRIEF DESCRIPTION OF THE DRAWINGS

FIG. 1 is a view illustrating a network for providing a virtual desktop service according to an exemplary embodiment of the present invention.

FIGS. 2 and 3 are flowcharts illustrating processes of providing a virtual desktop service according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the entire specification, unless explicitly described to the contrary, the word “comprise” and variations such as “comprises” or “comprising” will be understood to imply the inclusion of stated elements but not the exclusion of any other elements. In addition, the terms “. . . unit”, “. . . er”, “module”, and “block” described in the specification mean units for processing at least one function or operation, which may be realized by hardware, software, or a combination of hardware and software.

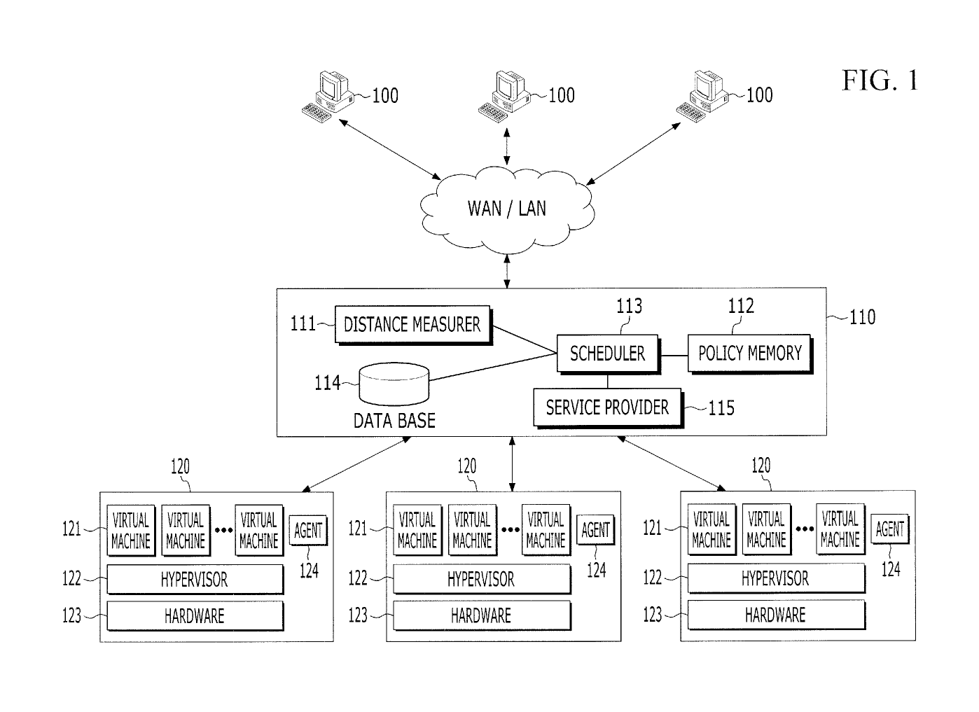

FIG. 1 is a view illustrating a virtual desktop service according to an exemplary embodiment of the present invention.

Referring to FIG. 1, a network that provides a virtual desktop service includes a management server 110 and a plurality of virtualization servers 120 connected to the management server.

The management server 110 may provide a virtual desktop realized by the plurality of virtualization servers 120 to users 100 through a wide area network (WAN) or a local area network (LAN).

The management server 110 includes a distance measurer 111, a policy memory 112, a scheduler 113, a database 114, and a service provider 115.

The distance measurer 111 measures distances between users and the plurality of virtualization servers 120 connected to the management server 110. At this time, “the distances” may be distances on a network (i.e., network distances) between the users and the virtualization servers 120.

The policy memory 112 may provide a policy to the scheduler 113 when the management server 110 selects at least one virtualization server among the plurality of virtualization servers 120 in order to provide the virtual desktop service to the users. The policy may be provided to the scheduler 113 with reference to information such as addresses of the virtualization servers 120 stored in the database 114 and allocation states of virtual machines 121.

The scheduler 113 selects a virtualization server 120 in accordance with the policy to transmit execute commands on virtual machines 121 to the selected virtualization server 120 and to store the result in the database 114.

In the database 114, information such as the addresses of the virtualization servers 120, selection states of the virtualization servers 120, and states of the virtual machines 121 allocated to each of the virtualization servers 120 are stored. In addition, in the database 114, information such as service usage patterns of the users and power usage amounts of the virtualization servers 120 may be stored.

The service provider 115 may provide a virtual desktop service to the users when virtual machines 121 are allocated to the virtualization server 120 selected by the scheduler 113.

The virtualization server 120 may drive the virtual machines 121 for providing the virtual desktop service to the users. That is, a hypervisor 122 of the virtualization server 120 may emulate the virtual machines 121 using hardware 123 included in the virtualization server 120.

In addition, the virtualization server 120 includes an agent 124 for receiving a request from the scheduler 113 of the management server 110 to allocate the virtual machines. The agent 124 may deliver usage amount information of various resources (a central processor unit (CPU), a memory, a network, and a disk) of the virtualization server 120, and allocation states and power usage statues of the virtual machines 121 to the database 114 of the management server 110.

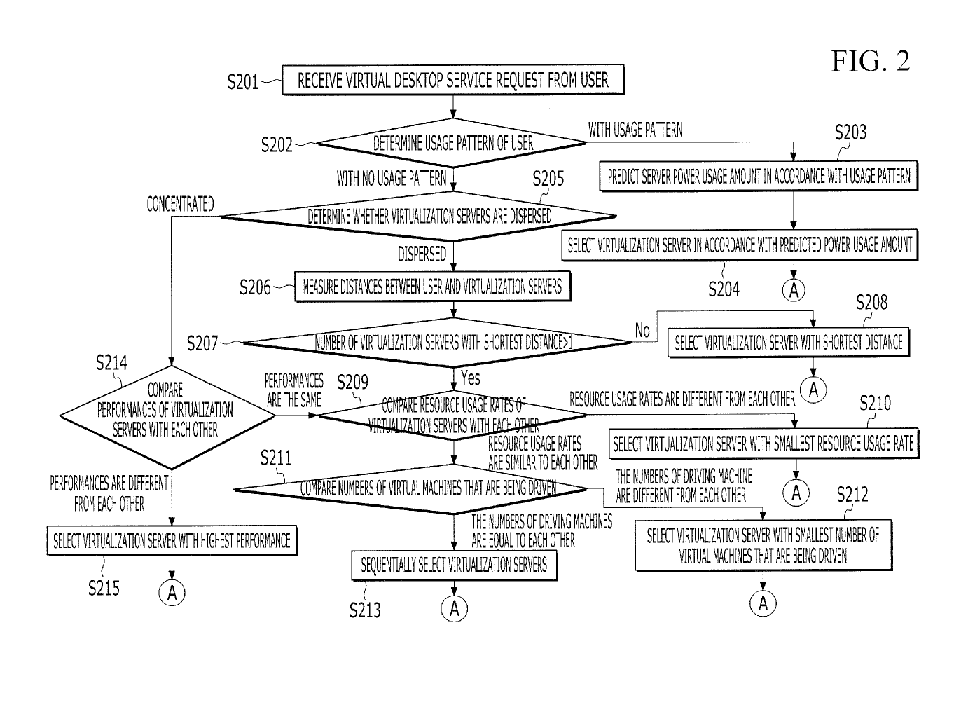

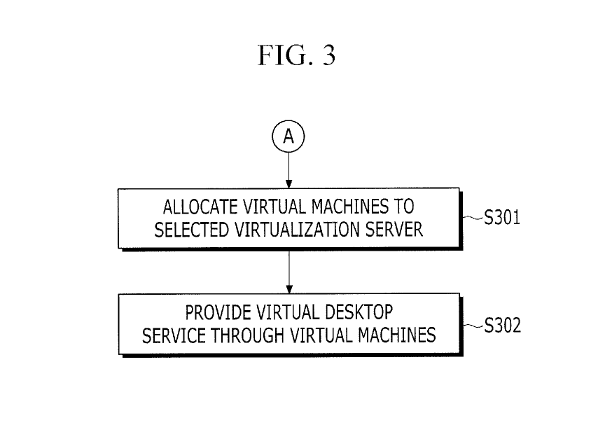

FIGS. 2 and 3 are flowcharts illustrating processes of providing a virtual desktop service according to an exemplary embodiment of the present invention.

Referring to FIGS. 2 and 3, first, when a user requests a virtual desktop service from the management server 110 through a communication network (S201), the scheduler 113 of the management server 110 selects a virtualization server 120 in which virtual machines are to be driven. At this time, the scheduler 113 may select a plurality of virtualization servers 120 in a similar range. According to an exemplary embodiment of the present invention, when resource usage rates of the virtualization servers are less than 50%, it is determined that virtualization servers whose resource usage rates are within ±5% are in a similar range, when resource usage rates of the virtualization servers are no less than 50% and less than 70%, it is determined that virtualization servers whose resource usage rates are within ±2% are in a similar range, and when resource usage rates of the virtualization servers are no less than 70%, it is determined that virtualization servers whose resource usage rates are within ±1% are in a similar range.

First, the management server 110 determines whether a usage pattern of a user is input to the database 114 (S202) to predict a server power usage amount in accordance with the input usage pattern (S203). Then, the management server 110 may select the virtualization server 120 in accordance with the predicted server power usage amount (S204).

The usage pattern of the user is calculated through an average usage amount of resources used by the user for a predetermined period. The usage pattern of the user may be calculated by a data mining technique.

For example, there is a large probability that a user who uses a virtual machine all day is in charge of work related to web searching. In this case, a network usage amount is large and all performances of a CPU and a memory that are allocated are not used. The user is estimated to have a network type (NT) user usage pattern. That is, after averaging usage amounts of resources such as a CPU, a memory, a network, and a disk used by the user, when the average value is substituted for a power usage predicting technique, a server power usage amount of the user may be predicted. User patterns such as a CPU type (CT), a network type (NT), a memory type (MT), and a disk type (DT) may exist.

However, when the usage pattern of the user is not input to the database 114, the management server 110 considers a dispersion degree of the virtualization servers 120 (S205) to measure distances between the user and the virtualization servers 120 when the virtualization servers 120 are dispersed (S206). The distances between the user and the virtualization servers 120 are distances on a network, and may be measured by an algorithm such as Internet distance maps (IDMaps), M-coop, king, and virtual landmarks.

Then, the management server 110 counts the number of virtualization servers 120 closest to the user on the network (with shortest network delay) (S207), and when one virtualization server 120 closest to the user exists, the virtualization server 120 is selected (S208).

When m virtualization servers 120 separated from the user by the same distance on the network exist, the management server 110 compares specifications of a plurality of virtual machines that are being driven in the m virtualization servers 120 with each other (S209) to select a virtualization server 120 with a smallest resource usage rate (S210).

That is, when the m virtualization servers 120 are connected to the management server 110, the management server provides weight values to CPUs, memories, and disks used by the virtualization servers 120, and compares the quantized values of the virtualization servers 120 with each other to select the virtualization server 120 with the smallest resource usage rate.

However, when resource usage rates of the m virtualization servers 120 are similar to each other, the management server 110 compares the numbers of virtual machines that are being driven in the respective virtualization servers 120 with each other (S211), and selects the virtualization server 120 with the smallest number of virtual machines that are being driven (S212).

That is, when the m virtualization servers 120 are connected to the management server 110, the numbers of virtual machines allocated to the respective virtualization servers 120 may be compared with each other to select the virtualization server 120 in which the smallest number of virtual machines are being driven.

In addition, when there is no difference in performance among the virtualization servers 120, resource usage rates of the respective virtualization servers 120 are in similar ranges, and when the numbers of virtual machines that are being driven in the virtualization servers 120 are equal to each other, the respective virtualization servers 120 are sequentially selected (S213). That is, when the m virtualization servers 120 are connected to the management server 110, the management server 110 may sequentially select the respective virtualization servers 120 to allocate the virtual machines.

On the other hand, when the virtualization servers 120 are locally concentrated, the management server 110 does not measure distances between the user and the virtualization servers 120 but compares performances of the plurality of virtualization servers 120 (S214) to select a virtualization server 120 with highest performance (S215). According to an exemplary embodiment of the present invention, a server with smallest power consumption may be determined as the virtualization server 120 with highest performance. That is, according to the exemplary embodiment of the present invention, when the virtualization servers 120 are locally concentrated, a server with a smallest power usage amount may be most preferentially selected.

However, when there is no difference in performance among the virtualization servers 120, the management server 110 compares specifications (specifications of CPUs, memories, and disks) of a plurality of virtual machines that are being driven in the respective virtualization servers 120 with each other (S209) to select the virtualization server 120 with a smallest resource usage rate (S210).

However, when there is no difference in performance among the virtualization servers 120 and resource usage rates of the respective virtualization servers 120 are similar to each other, the management server 110 selects the virtualization server 120 with the smallest number of virtual machines that are being driven therein (S212).

In addition, when there is no difference in performance among the virtualization servers 120, resource usage rates of the respective virtualization servers 120 are similar to each other, and when the numbers of virtual machines that are being driven in the respective virtualization servers 120 are equal to each other, the respective virtualization servers 120 are sequentially selected (S213).

The management server 110 may allocate virtual machines that perform similar work to one virtualization server 120 in accordance with a work type of the user. When virtual machines that perform similar work are driven in one virtualization server 120, performance may be improved using caching when a virtual desktop service is provided.

In this case, when a specific user requests a virtual desktop service for corresponding work, the management server 110 may select a virtualization server 120 designated in accordance with a work type of a specific user. Therefore, users that perform similar work are grouped to use virtual machines allocated to the same virtualization server 120 and to share a CPU, a memory, and cache.

Referring to FIG. 3, the scheduler 113 of the management server 110 then selects the virtualization server 120, and the agent 124 of the virtualization server 120 receives a request from the scheduler 113 to allocate virtual machines to the virtualization server 120 (S301).

Then, the service provider 115 of the management server 110 may provide a virtual desktop service to the user through the virtual machines performed by the selected virtualization server 120 (S302).

As described above, according to the exemplary embodiment of the present invention, a virtual desktop service suitable for a request of a user is provided to the user so that loads of servers may be dispersed and power usage of the servers may be minimized. That is, in an environment where the virtualization servers that provide the virtual desktop service are locally dispersed, the virtual machines may be allocated to a virtualization server with a shortest network delay based on network distances from the virtualization servers to the user. In addition, after a server power usage amount is predicted in accordance with a virtual machine usage type of the user, a virtualization server may be selected in accordance with the prediction result.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of providing a virtual desktop service to a user, the method comprising:
determining whether a plurality of virtualization servers included in a network are dispersed;
when it is determined that the plurality of virtualization servers are dispersed, measuring network distances between the user and the plurality of virtualization servers;
selecting at least one virtualization server among the plurality of virtualization servers based on the measured network distances; and
transmitting driving commands on virtual machines to the selected virtualization server.

2. The method of claim 1, wherein selecting the virtualization server comprises selecting a virtualization server with the shortest network distance among the plurality of virtualization servers.

3. The method of claim 1, wherein selecting the virtualization server comprises:
when m virtualization servers with the shortest network distance exist among the plurality of virtualization servers, comparing resource usage rates of the m virtualization servers with each other; and
selecting a virtualization server with the smallest resource usage rate.

4. The method of claim 3, further comprising:
when resource usage rates of the m virtualization servers are similar to each other, comparing the numbers of virtual machines that are being driven in the m virtualization servers with each other; and
selecting a virtualization server with the smallest number of virtual machines that are being driven among the m virtualization servers.

5. The method of claim 4, further comprising sequentially selecting the m virtualization servers when the numbers of virtual machines that are being driven in the m virtualization servers are equal to each other.

6. The method of claim 1, further comprising:
when the plurality of virtualization servers are concentrated, comparing performances of the plurality of virtualization servers with each other; and
selecting a virtualization server with highest performance among the plurality of virtualization servers.

7. A method of providing a virtual desktop service to a user, the method comprising:
when a virtual desktop service request is received from the user, predicting a server power usage amount in accordance with a usage pattern of the user;
selecting a virtualization server based on the server power usage amount; and
transmitting driving commands on virtual machines to the selected virtualization server.

8. The method of claim 7, wherein predicting the server power usage amount comprises calculating the usage pattern through an average resource usage amount of the user in a predetermined period.

9. The method of claim 8, wherein calculating the usage pattern comprises calculating the usage pattern by a data mining technique.

10. An apparatus for providing a virtual desktop service to a user, the apparatus comprising:
a distance measurer for, when a plurality of virtualization servers included in a network are dispersed, measuring network distances between the user and the plurality of virtualization servers;
a scheduler for selecting at least one virtualization server among the plurality of virtualization servers as a virtualization server for driving virtual machines in accordance with a policy and transmitting driving commands on the virtual machines to the selected virtualization server; and
a service provider for, when the virtual machines are driven, providing the virtual desktop service to the user.

11. The apparatus of claim 10, wherein the scheduler selects a virtualization server with the shortest measured network distance.

12. The apparatus of claim 11, wherein, when m virtualization servers with the shortest measured network distance exist, the scheduler compares resource usage rates of the m virtualization servers with each other to select a virtualization server with a smallest resource usage rate.

13. The apparatus of claim 12, wherein, when the resource usage rates of the m virtualization servers are similar to each other, the scheduler selects a virtualization server with the smallest number of virtual machines that are being driven.

14. The apparatus of claim 13, wherein, when the numbers of virtual machines that are being driven in the m virtualization servers are equal to each other, the scheduler sequentially selects the m virtualization servers.

15. The apparatus of claim 10, wherein the scheduler predicts a server power usage amount in accordance with a usage pattern of the user, and selects a virtualization server based on the predicted server power usage amount.

16. The apparatus of claim 15, wherein the scheduler calculates the usage pattern through an average resource usage amount of the user in a predetermined period.
